(19) United States
(12) Patent Application Publication
(10) Pub. No.: US 2026/0316068 A1
(43) Pub. Date: Oct. 15, 2026

(54) SAMPLING DEVICE FOR LIQUID TRANSFER, LIQUID TRANSFER DEVICE, METHOD, AND USE THEREOF

(71) Applicant: LIVOBOT CO.,LTD., Beijing (CN)

(72) Inventors: Dong WANG, Beijing (CN); Qianyang LIU, Beijing (CN); Keming SONG, Beijing (CN); Qiuyue CHEN, Beijing (CN)

(73) Assignee: LIVOBOT CO.,LTD., Beijing (CN)

(21) Appl. No.: 19/484,380

(22) PCT Filed: May 16, 2023
(86) PCT No.: PCT/CN2023/094470

§ 371 Date: Nov. 14, 2025

(51) Int. Cl. B01L 3/02

(52) U.S. Cl. CPC B01L 3/0217; B01L 2200/025; B01L 2200/0689; B01L 2400/0478

(57) ABSTRACT

A sampling device for liquid transfer, a liquid transfer device, a method, and use thereof are provided. The sampling device for liquid transfer includes: a base, on which a positioning boss is formed, with the bottom surface of the positioning boss serving as the mounting surface, which is a horizontal plane, and several positioning holes opened at intervals along the horizontal direction on the positioning boss; and several sampling heads, which correspond one-to-one with the positioning holes, with each sampling head inserted into the corresponding positioning hole to form a detachable fixed connection with the base. The sampling device for liquid transfer enables the placement and removal of sampling heads to achieve sealing through the positioning holes and height-direction positioning through the positioning boss of the sampling heads, avoiding the issue of inconsistent heights of disposable sampling heads during the installation and use of liquid transfer modules.

### CROSS REFERENCE TO THE RELATED APPLICATIONS

This application is the national phase entry of International Application No. PCT/CN 2023/094470, filed on May 16, 2023, the entire contents of which are incorporated herein by reference.

### TECHNICAL FIELD

This disclosure relates to the field of medical devices, particularly to a sampling device for liquid transfer, a liquid transfer device, a method, and use thereof.

### BACKGROUND

Liquid transfer workstations are indispensable, and liquid transfer modules are a crucial component. As shown in FIG. 1, a commonly used liquid transfer module includes multiple insertion rods and multiple sampling heads, with each insertion rod corresponding to one sampling head. Typically, sealing between a disposable sampling head 1 and its matching disposable sampling head adapter 2 is achieved using the inner contour of the disposable sampling head 1. In multi-channel liquid transfer modules that utilize the inner contour of disposable sampling heads for sampling, there are height errors among the various insertion rods. It is impossible to ensure that each insertion rod is at the same horizontal height, and the insertion depths of different insertion rods into the sampling heads cannot be guaranteed to be completely consistent. This results in issues such as inconsistent heights of disposable sampling heads and degraded airtightness during use, leading to differences in the volume of liquid taken, which in turn causes experimental results to fall short of expectations. Moreover, for multi-channel liquid transfer modules, it is usually necessary to install multiple disposable sampling head adapters into the module's cavity, requiring a high degree of parallelism among the adapters and placing stringent demands on the assembly precision of the liquid transfer module.

### SUMMARY

### Technical Problem

This disclosure aims to address the technical issues present in the prior art. To this end, it provides a sampling device for liquid transfer that can avoid problems caused by inconsistent heights of disposable sampling heads during the installation and use of liquid transfer modules, featuring a simple structure and easy installation.

### Technical Solution

In the first aspect, the disclosure provides a sampling device for liquid transfer, including:

a base, on which a positioning boss is formed, wherein the bottom surface of the positioning boss serves as the mounting surface, which is a horizontal plane; on this mounting surface, several positioning holes are opened at intervals along the horizontal direction;

several sampling heads, which correspond one-to-one with the positioning holes, wherein one end of each sampling head is inserted into the corresponding positioning hole to form a detachable sealed connection with the base, while the other end is used for liquid absorption.

Further, the two ends of the base are formed into connecting seats, located on either side of the positioning boss. Each connecting seat has a through-hole.

Further, a circular groove is formed inside each positioning hole, with a sealing ring placed within the groove. When the sampling head is inserted into the positioning hole, it abuts against the sealing ring.

Further, the cross-section of the sealing ring can be circular, rectangular, or star-shaped.

Further, at least one circular protrusion is formed at the top end of the sampling head. When the top end of the sampling head is inserted into the positioning hole, a sealed and fixed connection is formed through the circular protrusion.

Further, the top end of the sampling head is conical, with its diameter gradually decreasing from bottom to top, and the outer sidewall at the top end forms a conical surface. When the top end of the sampling head is inserted into the positioning hole, a fixed connection is formed through the wedge action of the conical surface.

Further, a limiting flange is also provided at the same position on the top of each sampling head. When the sampling head is inserted into the positioning hole, the limiting flange abuts against the mounting surface for limiting.

In the second aspect, the disclosure provides a liquid transfer device, including the aforementioned sampling device for liquid transfer, a mounting seat, several piston rods, and a piston fixing block. The mounting seat is sealed and fixedly connected to the base. Several cavities are formed horizontally on the mounting seat, corresponding one-to-one with the positioning holes. The corresponding cavities and positioning holes are aligned. One end of each piston rod is fixedly connected via the piston fixing block, while the other end is inserted into the corresponding cavity and can slide up and down along the inner wall of the cavity to absorb or discharge liquid through this up-and-down movement.

Further, the mounting seat and the base are fixedly connected by inserting bolts into the through-holes.

In the third aspect, the disclosure also provides a liquid transfer method for the aforementioned liquid transfer device, including the following steps:

a driving component drives the liquid transfer device to a position above the liquid;

a driving mechanism drives multiple piston rods upward, causing the cavities within the piston fixing block to form a negative pressure and absorb the required liquid through this negative pressure;

after absorbing the liquid, the driving component drives the liquid transfer device to the position wherein the liquid needs to be released, and the driving mechanism drives the piston rods downward to discharge the liquid from the cavities.

Further, the driving component and the driving mechanism can both be electric push rods, air cylinders, or hydraulic cylinders.

In the fourth aspect, the disclosure also provides use of the aforementioned liquid transfer device, which is used in cell analysis, biochemical analysis, physicochemical analysis, immunodetection, and gene detection.

### Beneficial Effects

By adopting the above technical solutions, this disclosure offers the following advantages.

The sampling device for liquid transfer provided by this disclosure enables the placement and removal of sampling heads to achieve sealing through the positioning holes and height-direction positioning through the positioning boss of the sampling heads, avoiding the issue of inconsistent heights of disposable sampling heads during the installation and use of liquid transfer modules. At the same time, multiple disposable sampling head positioning holes are machined in one go, eliminating the need for separate disposable sampling head adapters, reducing component complexity, and facilitating the assurance of assembly precision.

### BRIEF DESCRIPTION OF THE DRAWINGS

The accompanying drawings are provided to offer a further understanding of this disclosure and constitute a part of it. The schematic embodiments and their descriptions in the drawings are used to explain this disclosure and do not impose undue limitations on it.

FIG. 1 is a structural schematic diagram of a sampling device for liquid in the prior art.

FIG. 2 is a structural schematic diagram of a sampling device for liquid transfer from one embodiment of this disclosure, viewed from one angle.

FIG. 3 is a structural schematic diagram of the sampling device for liquid transfer from one embodiment of this disclosure, viewed from another angle.

FIG. 4 is a structural schematic diagram of a liquid transfer device provided by one embodiment of this disclosure.

FIG. 5 is a structural schematic diagram of the first implementation mode of the connection between the sampling head and the base.

FIG. 6 is a structural schematic diagram of the second implementation mode of the connection between the sampling head and the base.

FIG. 7 is a structural schematic diagram of the third implementation mode of the connection between the sampling head and the base.

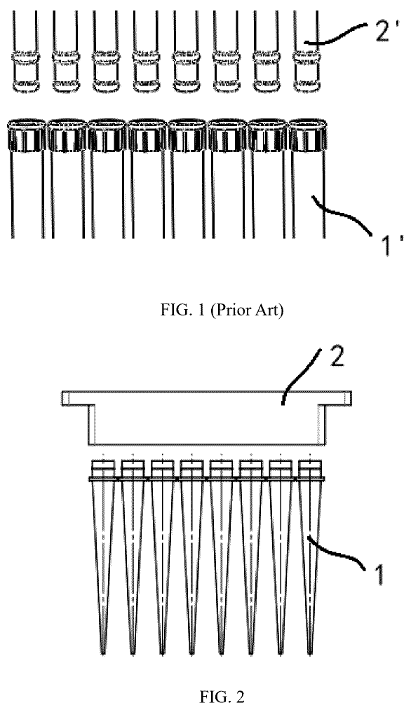

IN THE DRAWINGS, REFERENCE NUMBERS ARE SHOWN BELOW

1′1—sampling head, 2—base, 3—piston rod, 4—piston fixing block, 5—mounting seat, 11—top end, 12—circular protrusion, 21—positioning boss, 22—through-hole, 23—positioning hole, 11—top end, 12—sealing ring, 13—limiting flange.

### DETAILED DESCRIPTION OF THE EMBODIMENTS

In order to make the purpose, technical solutions, and advantages of this disclosure clearer, the technical solutions of this disclosure will be described clearly and completely in conjunction with the accompanying drawings. Obviously, the described embodiments are part of the embodiments of this disclosure, not all of them. Based on the embodiments of this disclosure, all other embodiments obtained by those of ordinary skill in the art without making creative efforts fall within the protection scope of this disclosure.

In the description of this disclosure, it should be noted that terms such as “upper,” “lower,” “axial,” “circumferential,” “horizontal,” and “vertical” indicating orientations or positional relationships are based on the orientations or positional relationships shown in the drawings, merely for the convenience of describing this disclosure and simplifying the description, rather than indicating or implying that the referred-to system or component must have a specific orientation or be constructed and operated in a specific orientation, and thus cannot be construed as a limitation on this disclosure. In addition, terms such as “first” and “second” are used to distinguish components, and unless otherwise specified, these terms do not have special meanings and cannot be construed as indicating or implying relative importance.

In the description of this disclosure, it should be noted that unless otherwise clearly defined and limited, terms such as “assembly,” “setup,” and “connection” should be broadly understood. For example, they can refer to fixed connections, detachable connections, or integral connections; they can also refer to mechanical connections or electrical connections; they can be direct connections or indirect connections through intermediate media, and can involve the internal communication of two components. For those of ordinary skill in the art, the specific meanings of these terms in this disclosure can be understood on a case-by-case basis.

The embodiments of this disclosure provide a sampling device for liquid transfer, which avoids the issue of inconsistent heights of disposable sampling heads after installation, thereby preventing differences in the volume of liquid transferred, improving the reliability and accuracy of experiments, and also avoiding problems of degraded airtightness in the connection of sampling heads.

Below, a detailed description of the sampling device for liquid transfer and the liquid transfer device provided by the embodiments of this disclosure will be given in conjunction with the accompanying drawings.

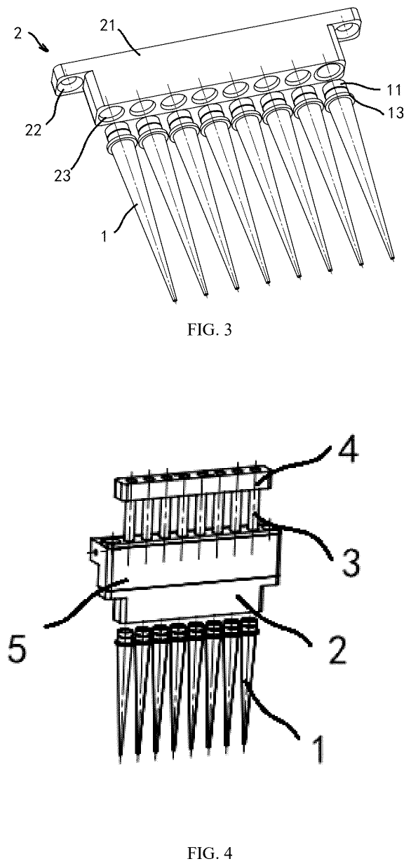

As shown in FIGS. 2 to 3, the sampling device for liquid transfer includes a base 2 and several sampling heads 1. A positioning boss 21 is formed on the base 2, with the bottom surface of the positioning boss 21 serving as the mounting surface, which is a horizontal plane. Several positioning holes 23 are opened at equal intervals along the horizontal direction on the mounting surface. The several sampling heads 1 correspond one-to-one with the several positioning holes 23, with each sampling head 1 inserted into the corresponding positioning hole 23 to form a detachable sealed fixed connection with the base 1.

In this disclosure, the placement and removal of disposable sampling heads achieve sealing through the positioning holes 23 set on the base and height-direction positioning through the positioning boss 21, avoiding the issue of inconsistent heights of sampling heads 1 during the installation and use of the liquid transfer device. At the same time, multiple positioning holes 23 are machined in one go, eliminating the need for separate disposable sampling head adapters, reducing component complexity, and facilitating the assurance of assembly precision.

Preferably, the multiple positioning holes 23 are machined in one go, and their heights are kept consistent, improving the accuracy of the volume of liquid transferred and the reliability of experiments.

The two ends of the base 2 are formed into connecting seats, with the two connecting seats located on either side of the positioning boss 21 and having through-holes 22.

A limiting flange 13 is also provided at the same position on the top of each sampling head 1, and the limiting flange 13 abuts against the horizontal surface of the positioning boss 21 for limiting. The cooperation between the limiting flange 13 and the horizontal surface of the positioning boss 21 can further ensure that the insertion depths of each sampling head 1 into the positioning holes 23 are the same. Therefore, compared to the method in the prior art where insertion rods are inserted into the sampling heads 1, in this application, inserting the sampling heads 1 into the positioning holes on the base 2 and the cooperation between the limiting flanges 13 on the sampling heads 1 and the horizontal surface on the base 2 can further improve installation accuracy and ensure that each sampling head is at the same horizontal position after installation.

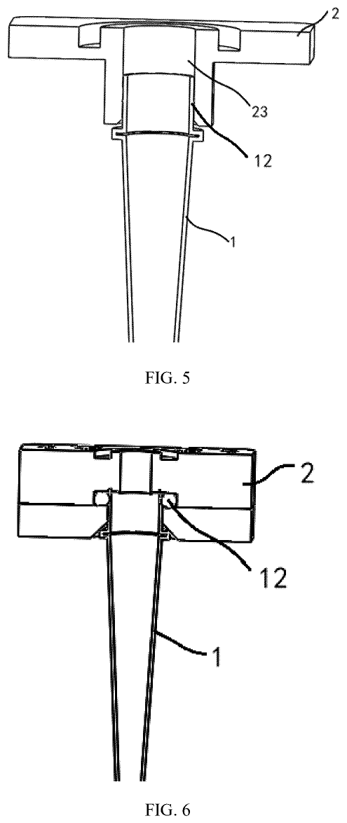

As shown in FIG. 5, the top end 11 of the sampling head 1 is connected to the positioning hole 23 in an inserted manner, with the top end 11 of the sampling head 1 directly inserted into the positioning hole 23 to form a fixed connection.

In order to achieve a sealed connection and improve sealing reliability, as the first implementation mode, at least one circular protrusion 12 is formed at the top end 11 of the sampling head 1. When the top end of the sampling head 1 is inserted into the positioning hole 23, a sealed fixed connection is formed through the circular protrusion 12.

As the second implementation mode, as shown in FIG. 6, to improve the sealing performance of the connection between the sampling head 1 and the base 2, a circular groove is formed inside the positioning hole 23, with a sealing ring 12 placed within the groove. The sampling head 1 is inserted into the positioning hole 23 and abuts against the sealing ring 12.

The cross-section of the sealing ring 12 can be circular, rectangular, star-shaped, or other irregular shapes. An O-ring is preferred.

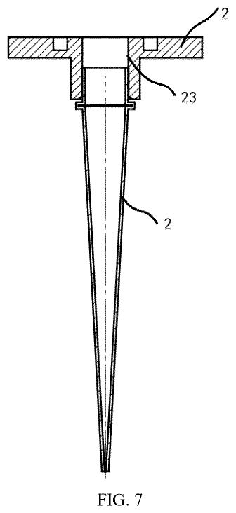

As the third implementation mode, as shown in FIG. 7, the top end of the sampling head 1 is conical, with its diameter gradually decreasing from bottom to top, and the top end 11 forms a conical surface. When the top end 11 of the sampling head 1 is inserted into the positioning hole 23, a fixed connection is formed through the wedge action of the conical surface.

In order to facilitate installation and connection, two connecting protrusions are also symmetrically formed on either side of the positioning boss 21, with through-holes 22 opened on both connecting seats.

Preferably, the several positioning holes 23 are set at equal intervals.

As shown in FIG. 4, the embodiments of this disclosure also provide a liquid transfer device, including the aforementioned sampling device for liquid transfer, a mounting seat 5, several piston rods 3, and a piston fixing block 4. The mounting seat 5 is sealed and fixedly connected to the base 2. Several cavities are formed horizontally on the mounting seat 5, corresponding one-to-one with the positioning holes 23, with the corresponding through-holes and positioning holes 23 aligned. One end of each piston rod 3 is fixedly connected via the piston fixing block 4, while the other end is inserted into the corresponding cavity and can slide up and down along the cavity to absorb or discharge liquid through this up-and-down movement.

Preferably, the mounting seat 5 and the base 2 are fixedly connected by bolts, specifically by inserting bolts through the through-holes 22 to fix them to the mounting seat.

The working process of the liquid transfer device is as follows, including the steps.

A driving component drives the liquid transfer device to a position above the liquid.

A driving mechanism drives multiple piston rods 3 upward, causing the cavities within the piston fixing block 4 to form a negative pressure and absorb the required liquid through this negative pressure.

After absorbing the liquid, the driving component drives the liquid transfer device to the position where the liquid needs to be released, and the driving mechanism drives the piston rods 3 downward to discharge the liquid from the cavities.

The driving component can be an electric push rod, air cylinder, or hydraulic cylinder.

The embodiments of this disclosure also provide use of the aforementioned liquid transfer device, which is used in cell analysis, biochemical analysis, physicochemical analysis, immunodetection, and gene detection.

The sampling device for liquid transfer provided by this disclosure can improve sampling accuracy and features a simple structure and convenient installation.

The above embodiments are merely used to illustrate this disclosure, and all components of the embodiments can be varied. All implementation modes obtained by appropriate combinations or deletions based on the needs are also considered within the scope of this disclosure. Not all components shown in the drawings are necessarily required, and the general principles defined herein can be implemented in other embodiments without departing from the spirit or scope of this disclosure. Therefore, this disclosure will not be limited to the embodiments described herein, and any embodiments that fall within the scope of the claims and their equivalents are included in this disclosure.

What is claimed is:

1. A sampling device for liquid transfer, comprising:
a base provided with a positioning boss, wherein a bottom surface of the positioning boss is a mounting surface, the mounting surface is a horizontal plane, and a plurality of positioning holes are provided at intervals along a horizontal direction on the mounting surface; and
a plurality of sampling heads corresponding one-to-one with the plurality of positioning holes, wherein a first end of each sampling head of the plurality of sampling heads is inserted into the corresponding positioning hole to form a detachable sealed connection with the base, and a second end of each sampling head is configured to absorb liquid.

2. The sampling device for liquid transfer according to claim 1, wherein two ends of the base are formed into two connecting seats, wherein the two connecting seats are located on either side of the positioning boss, and the two connecting seats are provided with through-holes.

3. The sampling device for liquid transfer according to claim 2, wherein a circular groove is formed inside each positioning hole of the plurality of positioning holes, with a sealing ring placed within the circular groove, and the sampling head is inserted into the positioning hole and abuts against the sealing ring.

4. The sampling device for liquid transfer according to claim 3, wherein cross-section of the sealing ring is circular, rectangular, or star-shaped.

5. The sampling device for liquid transfer according to claim 2, wherein at least one circular protrusion is formed at a top end of the sampling head, and when the top end of the sampling head is inserted into the positioning hole, a sealed fixed connection is formed through the at least one circular protrusion.

6. The sampling device for liquid transfer according to claim 2, wherein a top end of the sampling head is conical and has a diameter gradually decreasing from bottom to top, and an outer sidewall at the top end forms a conical surface;
and when the top end of the sampling head is inserted into the positioning hole, a fixed connection is formed through a wedge action of the conical surface.

7. The sampling device for liquid transfer according to claim 1, wherein a limiting flange is also provided at a same position on a top of each sampling head, and when the sampling head is inserted into the positioning hole, the limiting flange abuts against the mounting surface for limiting.

8. A liquid transfer device, comprising:
the sampling device for liquid transfer according to claim 1,
a mounting seat,
a plurality of piston rods, and
a piston fixing block,
wherein the mounting seat is sealed and fixedly connected to the base, a plurality of cavities are formed horizontally on the mounting seat corresponding one-to-one with the plurality of positioning holes, the corresponding cavities and positioning holes are aligned, a first end of each piston rod of the plurality of piston rods is fixedly connected via the piston fixing block, and a second end of each piston rod is inserted into the corresponding cavity and slides up and down along an inner wall of the cavity to absorb or discharge liquid through an up-and-down movement.

9. The liquid transfer device according to claim 8, wherein the mounting seat and the base are fixedly connected by bolts.

10. A liquid transfer method for the liquid transfer device according to claim 9, comprising:
driving, by a driving component, the liquid transfer device to a position above the liquid;
driving, by a driving mechanism, the plurality of piston rods upward, causing the plurality of cavities within the piston fixing block to form a negative pressure and absorbing the required liquid through the negative pressure; and
after absorbing the liquid, driving, by the driving component, the liquid transfer device to a position where the liquid needs to be released, and driving, by the driving mechanism, the plurality of piston rods downward to discharge the liquid from the plurality of cavities.

11. The liquid transfer method according to claim 10, wherein the driving component and the driving mechanism are both electric push rods, air cylinders, or hydraulic cylinders.

12. A use method of the liquid transfer device according to claim 8, comprising: applying the liquid transfer device in cell analysis, biochemical analysis, physicochemical analysis, immunodetection, and gene detection.

13. The liquid transfer device according to claim 8, wherein in the sampling device for liquid transfer, two ends of the base are formed into two connecting seats, wherein the two connecting seats are located on either side of the positioning boss, and the two connecting seats are provided with through-holes.

14. The liquid transfer device according to claim 13, wherein in the sampling device for liquid transfer, a circular groove is formed inside each positioning hole of the plurality of positioning holes, with a sealing ring placed within the circular groove, and the sampling head is inserted into the positioning hole and abuts against the sealing ring.

15. The liquid transfer device according to claim 14, wherein in the sampling device for liquid transfer, cross-section of the sealing ring is circular, rectangular, or star-shaped.

16. The liquid transfer device according to claim 13, wherein in the sampling device for liquid transfer, at least one circular protrusion is formed at a top end of the sampling head, and when the top end of the sampling head is inserted into the positioning hole, a sealed fixed connection is formed through the at least one circular protrusion.

17. The liquid transfer device according to claim 13, wherein in the sampling device for liquid transfer, a top end of the sampling head is conical and has a diameter gradually decreasing from bottom to top, and an outer sidewall at the top end forms a conical surface; and
when the top end of the sampling head is inserted into the positioning hole, a fixed connection is formed through a wedge action of the conical surface.

18. The liquid transfer device according to claim 8, wherein in the sampling device for liquid transfer, a limiting flange is also provided at a same position on a top of each sampling head, and when the sampling head is inserted into the positioning hole, the limiting flange abuts against the mounting surface for limiting.

19. The liquid transfer method according to claim 10, wherein in the liquid transfer device, the mounting seat and the base are fixedly connected by bolts.

20. The use method according to claim 12, wherein in the liquid transfer device, the mounting seat and the base are fixedly connected by bolts.
